(19) United States
(12) Patent Application Publication
(10) Pub. No.: US 2020/0021787 A1
(43) Pub. Date: Jan. 16, 2020

(54) PROJECTOR, PROJECTION METHOD, IMAGE PROCESSING SYSTEM, AND METHOD

(71) Applicant: SONY CORPORATION, TOKYO (JP)

(72) Inventor: KIYOTO SOMEYA, TOKYO (JP)

(21) Appl. No.: 16/487,288

(22) PCT Filed: Mar. 9, 2018
(86) PCT No.: PCT/JP2018/009154

§ 371 Date: Aug. 20, 2019

(30) Foreign Application Priority Data
Mar. 23, 2017 (JP) 2017-056999

(51) Int. Cl. H04N 9/31; H04N 5/74; G03B 21/14; G02B 27/64

(52) U.S. Cl. CPC H04N 9/3185; H04N 5/74; G03B 2205/0007; G02B 27/648; G03B 21/145

(57) ABSTRACT

The present disclosure relates to a projector, a projection method, an image processing system, and a method that make it possible to realize hand shake correction. A projection imaging apparatus includes a geometric correction section, a corresponding point detection section, a posture estimation section, a screen reconfiguration section, a projector, and a camera. An input video is input to the geometric correction section. The projector houses an IMU (inertial measurement apparatus) and a delay compensation circuit. For example, the present disclosure can be applied to the projection imaging apparatus that projects an image by using the projector, captures the image projected by the projector, and performs correction.

### TECHNICAL FIELD

The present disclosure relates to a projector, a projection method, an image processing system, and a method. More particularly, the present disclosure relates to a projector, a projection method, an image processing system, and a method that make it possible to realize hand shake correction.

### BACKGROUND ART

In the case in which a relationship in a three-dimensional space between a projector and a projection target (for example, a screen, a three-dimensional object, or the like) is unknown, depth sensing is performed, a positional posture in the three-dimensional space between the projector and the projection target is estimated, and a video is corrected and projected so as to be correctly projected onto the projection target (refer to PTL 1).

### CITATION LIST

### Patent Literature

[PTL 1]

JP 2009-135921A

### SUMMARY

### Technical Problem

In the case in which the depth sensing is performed while a video is projected by a hand projector, various delays are introduced from the depth sensing to the video correction. The corrected video is corrected so as to be correctly viewed in a positional posture between the projector and the projection target at the time when the depth sensing is performed. However, in the case of the hand projector through the above-described delay, a posture of the projector is already changed in consequence of the hand shake etc. As a result, it is difficult to project a correct video in some cases.

The present disclosure has been made in view of such a situation as described above, and it is an object of the present disclosure to make it possible to realize hand shake correction.

### Solution to Problem

A projector of one aspect of the present technology includes: an inertial measurement section; a correction section configured to correct a posture deviation on the basis of a measurement value in which a geometric-corrected corrected image is measured by the inertial measurement section; and a projection section configured to project an image in which the posture deviation is corrected by the correction section.

In the correction section, a delay regarding any one of geometric correction, a corresponding point detection, and a posture estimation includes a transmission delay or a processing delay.

The correction section may perform correction to shift in a direction of eliminating the posture deviation.

The correction section may correct the posture deviation due to an exposure delay of an imaging section that captures a projected image projected by the projection section.

The correction section may correct the posture deviation due to a delay that is caused in the projector.

A projection method of one aspect of the present technology includes correcting a posture deviation on the basis of a measurement value in which a geometric-corrected corrected image is measured by an inertial measurement section; and projecting an image in which the posture deviation is corrected.

An image processing system of another aspect of the present technology includes an image processing apparatus and a projector. The image processing apparatus includes: a correction section configured to correct an input image and generate a corrected image on the basis of posture estimation information regarding a projector; a corresponding point detection section configured to match a captured image generated by capturing a projected image that is an image in which the corrected image generated by the correction section is projected from the projector with the corrected image and detect a corresponding point; and a posture estimation section configured to perform a posture estimation of the projector and generate the posture estimation information on the basis of the corresponding point detected by the corresponding point detection section. The projector includes: an inertial measuring section; and a delay compensation section configured to correct a posture deviation due to a delay regarding any one of the corresponding point detection section, the posture estimation section, and the correction section on the basis of a measurement value of the inertial measuring section.

The delay regarding any one of the corresponding point detection section, the posture estimation section, and the correction section includes a transmission delay or a processing delay.

The delay compensation section may perform correction to shift in a direction of eliminating the posture deviation.

The delay compensation section may compensate an exposure delay of an imaging section that captures the projected image.

The delay compensation section may compensate a delay that is caused in the projector.

An image processing method of another aspect of the present technology includes: correcting, by a correction section of an image processing apparatus, an input image and generating a corrected image on the basis of posture estimation information regarding a projector; matching, by a corresponding point detection section, a captured image generated by capturing a projected image that is an image in which the corrected image generated by the correction section is projected from the projector with the corrected image and detecting a corresponding point; performing, by a posture estimation section, a posture estimation of the projector and generating the posture estimation information on the basis of the corresponding point detected by the corresponding point detection section; and correcting, by a delay compensation section of the projector, a posture deviation due to a delay regarding any one of the corresponding point detection section, the posture estimation section, and the correction section on the basis of a measurement value of an inertial measuring section of the projector.

In one aspect of the present technology, a posture deviation is corrected, on the basis of a measurement value in which a geometric-corrected corrected image is measured by the inertial measurement section, and an image in which the posture deviation is corrected is projected.

In another aspect of the present technology, by a correction section, an input image is corrected and a corrected image is generated on the basis of posture estimation information regarding a projector; by a corresponding point detection section, there is matched a captured image generated by capturing a projected image that is an image in which the corrected image generated by the correction section is projected from the projector with the corrected image and a corresponding point is detected; and by a posture estimation section, a posture estimation of the projector is performed and the posture estimation information is generated on the basis of the corresponding point detected by the corresponding point detection section. By a delay compensation section of the projector, a posture deviation due to a delay regarding any one of the corresponding point detection section, the posture estimation section, and the correction section is corrected on the basis of a measurement value of an inertial measuring section of the projector.

### Advantageous Effect of Invention

According to the present technology, it is possible to realize the hand shake correction.

Meanwhile, the effect described in this specification is illustrative only; the effect of the present technology is not limited thereto and there may also be an additional effect.

### [BRIEF DESCRIPTION OF DRAWINGS]

FIG. 1 is a block diagram illustrating a configuration example of a projection imaging apparatus to which the present technology is applied.

FIG. 2 is a process diagram for describing projection imaging processing.

FIG. 3 is a diagram for describing an example of an ISL.

FIG. 4 is a diagram for describing a method for matching feature points with each other among moving images.

FIG. 5 is a diagram for describing a delay in the projection imaging processing.

FIG. 6 is a diagram for describing an example of a light emitting system.

FIG. 7 is a flowchart for describing the projection imaging processing.

FIG. 8 is a block diagram illustrating a hardware configuration example of a computer to which the present technology is applied.

### DESCRIPTION OF EMBODIMENTS

Hereinafter, modes for carrying out the present disclosure (hereinafter, referred to as embodiments) will be described.

### <Outline>

In the case in which a relationship in a three-dimensional space between a projector and a projection target (for example, a screen, a three-dimensional object, or the like) is unknown, depth sensing is performed, a positional posture in the three-dimensional space between the projector and the projection target is estimated, and a video is corrected and projected so as to be correctly projected on the projection target.

In the case in which the depth sensing is performed while a video is projected by a hand projector, various delays are introduced from the depth sensing up to the video correction. The corrected video is corrected so as to be correctly viewed in a positional posture between the projector and the projection target at the time when the depth sensing is performed. However, in the case of the hand projector through the above-described delay, a posture of the projector is already changed in consequence of a hand shake or the like. As a result, it is difficult to project a correct video in some cases.

Similar circumstances may be seen even at the time of viewing a VR (virtual reality) video using a head mounted display. In the VR viewing, it is necessary to draw (rendering of 3D graphics) a video displayed in goggles in accordance with movements of the head of a user. However, it takes a fixed amount of time (that is, a delay) to render the 3D graphics and therefore a VR sickness is caused.

To solve the above problem, in the case in which a position of the head at the time of rendering the 3D graphics is deviated from a position of the head at a display timing, simple correction is performed in a position to be originally drawn immediately before the display timing to thereby reduce the VR sickness.

In the above-described method, the delay (deviation of the head) due to the rendering of the 3D graphics is corrected in accordance with timing of an external output (HDMI (registered trademark) or DP) of a GPU that is housed in a personal computer or the like. Therefore, it is supposed that there is no (almost no) delay on the side of a display device.

In the case in which the display device is a projector, there is a high possibility that an external input signal is accumulated in an internal frame memory once and then a video is actually projected in accordance with a difference of functions housed in the projector (high-quality image process such as high-frame rate), a color display system (single plate type or three plate type), a light emitting system (DLP, LCD, or LCoS), or the like. Therefore, there is a possibility that even if the video is a correction video that is delay-compensated on the external output side (for example, a GPU housed in a PC, or the like), a correct video cannot be projected due to a delay on the side of the display device.

To solve the above problem, in the present technology, the inertial measurement apparatus (IMU) is housed on the side of the projector that is the display device and a delay compensation is performed on the side of the projector.

### <Configuration Example of Projection Imaging Apparatus>

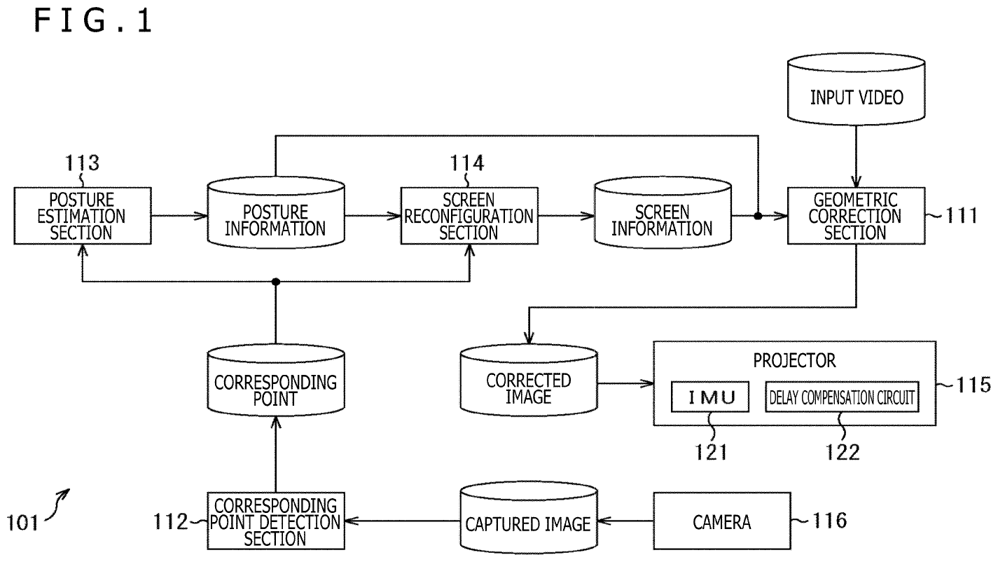

FIG. 1 is a block diagram illustrating a configuration example of a projection imaging apparatus to which the present technology is applied.

In an example illustrated in FIG. 1, a projection imaging apparatus 101 includes a geometric correction section 111, a corresponding point detection section 112, a posture estimation section 113, a screen reconfiguration section 114, a projector 115, and a camera 116. An input video is input to the geometric correction section 111.

The geometric correction section 111 corrects the input video. On the basis of posture information regarding the projector and screen information, the geometric correction section 111 corrects the input video so that the input video can be correctly viewed, and further generates a corrected image and outputs the generated corrected image to the projector 115.

The projector 115 projects the corrected image onto the screen. The projector 115 houses an IMU (inertial measurement apparatus) 121 and a delay compensation circuit 122. The IMU 121 instantaneously measures a posture change in a posture of the projector 115. The delay compensation circuit 122 compensates a posture deviation due to various delays caused in each portion of the projection imaging apparatus 101. On the basis of a measurement value of the IMU 121, for example, the delay compensation circuit 122 performs correction to shift a video in a direction of eliminating video deviation and blurring due to the hand shake. Note that the above is described as the hand shake and further even blurring other than the hand shake is contained.

The camera 116 captures the projected image projected on the screen from the projector 115, generates the captured image, and supplies the capture image to the corresponding point detection section 112. The camera 116 may be a depth sensor.

Note that even the projector 115 and the camera 116 may be arranged in plurality. Alternatively, one camera 116 may be arranged for the projector 115, one camera 116 may be arranged for a plurality of projectors 115, or one projector 115 may be arranged for a plurality of cameras 116.

The corresponding point detection section 112 performs corresponding point detection processing (depth sensing) on the projector 115 and the camera 116.

The posture estimation section 113 estimates a relative posture between the projector 115 and the camera 116 on the basis of the detected corresponding point. Then, the posture estimation section 113 supplies the estimated posture information regarding the projector to the screen reconfiguration section 114 and the geometric correction section 111.

The screen reconfiguration section 114 performs screen shape estimation and position alignment with a plane screen by referring to the posture information. Then, the screen reconfiguration section 114 supplies that result to the geometric correction section 111 as the screen information.

<Details from Corresponding Point Detection up to Geometric Correction>

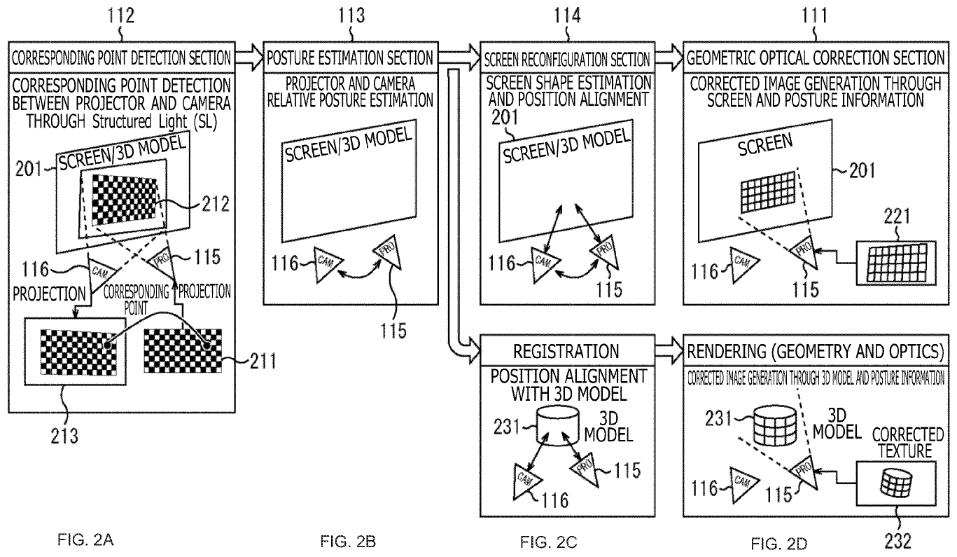

Next, details from a corresponding point detection up to geometric correction will be described with reference to FIG. 2. In order to detect a corresponding point between the projector 115 and the camera 116, as illustrated in A of FIG. 2, the corresponding point detection section 112 detects the corresponding point by using the captured image 213 obtained by capturing an image (an input image, a pattern image such as a Gray Code, a Dot, and a Checker, or the like) 211 to be projected from the projector 115 and the projected image 212 obtained by projecting the image 211 on a screen 201 by using the camera 116. The corresponding point detection processing is generally referred to as Structured Light (SL: Structured Light).

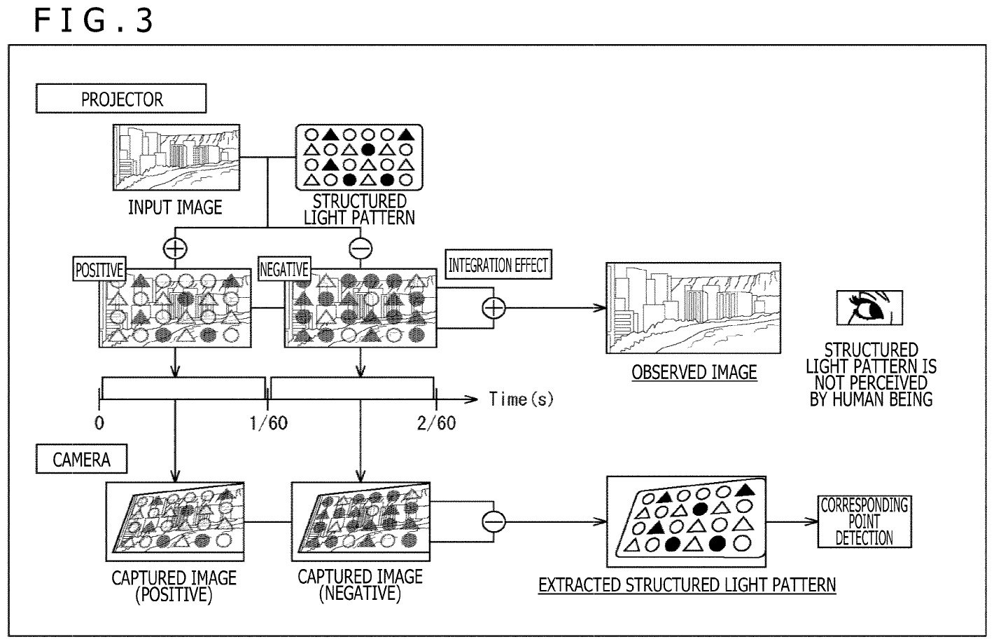

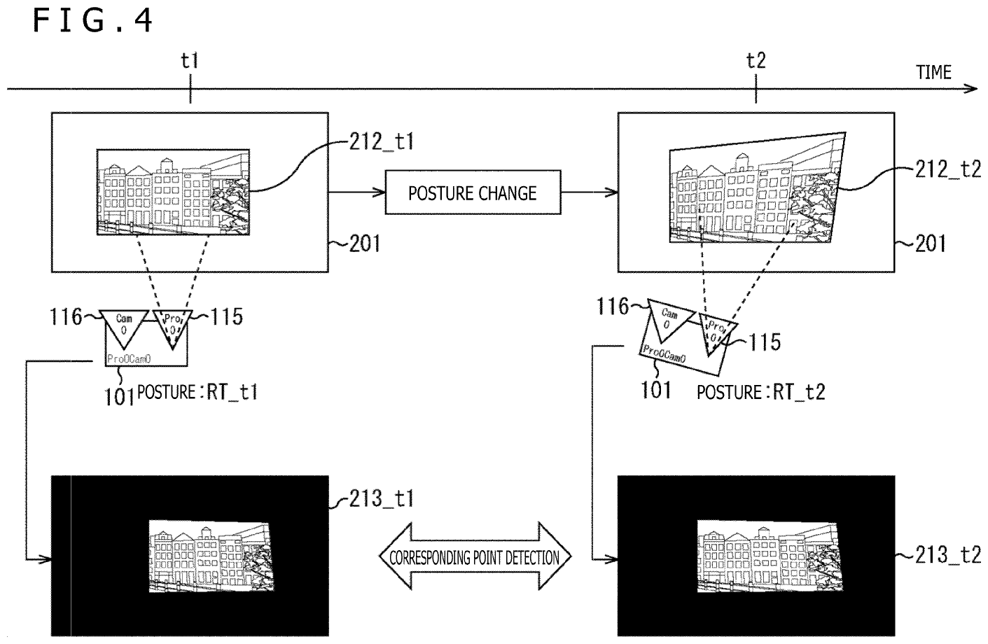

Here, a method for detecting a corresponding point while projecting a moving image and estimating postures of the projector 115 and the camera 116 is referred to as online sensing. Examples of an online sensing method for detecting the corresponding points include Imperceptible Structured Light (ISL) (FIG. 3) in which a pattern that is not perceived by human eyes in a moving image is overlapped with each other to detect the corresponding point, a method for detecting feature points in a moving image and matching both of the feature points with each other (FIG. 4), a method for projecting a pattern image on light other than visible light such as an IR light source, and the like.

An ISL system is a technique in which a structured light pattern that is an image of a predetermined pattern is positive-negative inverted, embedded in a projected image, and is projected so as not to be perceived by a human being.

As illustrated in FIG. 3, the projector adds a predetermined structured light pattern to a certain frame in the input image and thereby generates a frame image in which a positive image of the structured light pattern is synthesized with the input image. By contrast, the projector subtracts the structured light pattern from the next frame in the input image and thereby generates a frame image in which a negative image of the structured light pattern is synthesized with the input image. Further, the projector continuously projects those frames. Two positive and negative frames that are switched at high speed are perceived to be added to each other by the human eyes due to an integration effect. As a result, it is difficult for the user who views the projected image to recognize the structured light pattern that is embedded in the input image.

By contrast, the camera captures the projected images of those frames and finds a difference between the captured images of both frames. Thereby, the camera extracts only the structured light pattern included in the captured image. The corresponding point detection is performed by using the extracted structured light pattern.

As described above, the difference between the captured images is only found in the ISL system to thereby extract the structured pattern easily. Therefore, the corresponding point detection can be performed with stable accuracy without depending on the projected image.

Further, a method for detecting future points in a moving image and matching both of the feature points with each other will be described with reference to FIG. 4. At a time t1, the projector (projection section) 115 and the camera (imaging section) 116 of the projection imaging apparatus 101 each have a posture RT_t1. At this time, the projector 115 projects a projected image 212_t1 onto the screen 201 and the camera 116 captures the projected image 212_t1 and generates the captured image 213_t1.

Then, at a time t2, postures of the projector (projection section) 115 and the camera (imaging section) 116 of the projection imaging apparatus 101 are changed. The projector (projection section) 115 and the camera (imaging section) 116 of the projection imaging apparatus 101 each have a posture RT_t2. At this time, the projector 115 projects a projected image 212_t2 onto the screen 201 and the camera 116 captures the projected image 212_t2 and generates a captured image 213_t2.

As described above, in the act of projecting the input video, the corresponding points are detected in the generated captured image 213_t1 at the time t1 and the generated captured image 213_t2 at the time t2. Therefore, there is given an advantage of being able to automatically update the posture of the projector in a correct video presentation position even if it is changed due to disturbances (the above-described pattern image is not necessarily projected).

Next, as illustrated in B of FIG. 2, information regarding the corresponding point is transferred to the posture estimation section 113 and the postures of the projector 115 and the camera 116 are estimated. Next, as illustrated in an upper stage of C of FIG. 2, as a screen reconfiguration, in the case in which a projection target is the screen 201 or a wall, the position alignment between a shape estimation of the projection target and a projection target of the projector 115 is performed. Further, as illustrated in an upper stage of D of FIG. 2, the geometric correction (keystone correction, correction of an uneven surface of a wall, or the like) is performed so that the video is correctly displayed on the screen 201 on the basis of the posture information regarding the projector 115 and the shape information regarding the screen 201.

By contrast, in the case in which the projection target is a 3D model 231, a position alignment between the 3D model 231 and the projection targets is performed as illustrated in a registration of a lower stage of C of FIG. 2. Further, as illustrated in rendering (geometry and optics) of a lower stage of D of FIG. 2, a texture 232 is corrected (so-called projection mapping) so that a texture of the 3D model 231 fits perfectly to the projection target. Note that a depth may be directly measured like not only the depth sensing through the structured light but also a TOF (Time-of-Flight) camera.

In the online sensing, the corresponding point detection can be performed in the act of projecting a video content. Therefore, even if the posture of the projector is changed during a video projection, it is possible to correct a video so as to correctly view the video in a short time. However, in the case in which the video is projected by the hand projector, the posture of the projector is always changed due to the hand shake. Therefore, there occurs a problem that when a sensor having high response capable of following the hand shake does not exist, the video presentation position continues to be always blurred.

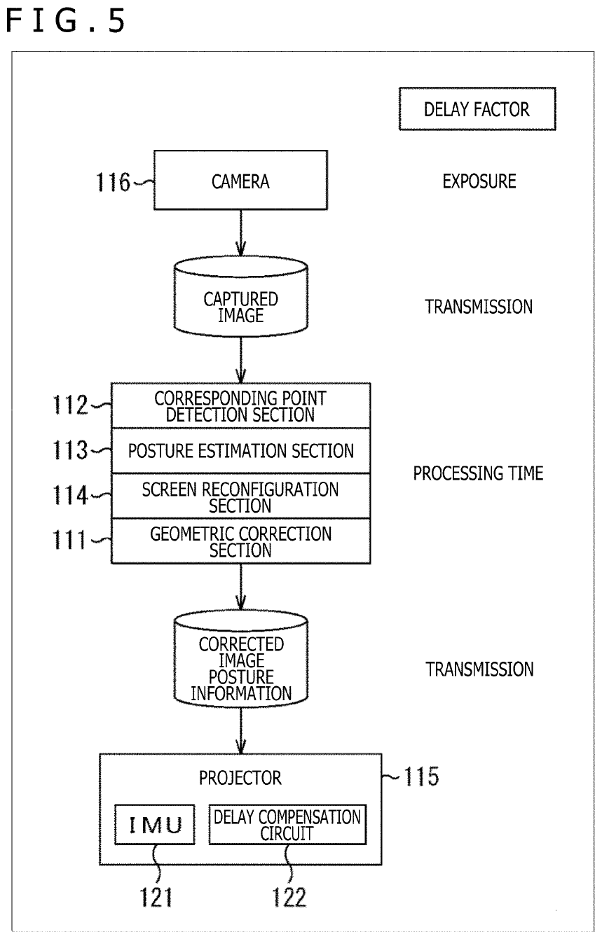

In a series of processing described above with reference to FIG. 2, various delays are caused as illustrated in FIG. 5. Each section of the projection imaging apparatus 101 is indicated on the left side of FIG. 5 and delay factors are indicated on the right side thereof. First, since a pattern projected from the projector is theoretically photographed by the camera 116, a film needs to be exposed during a period in which a pattern is lighted and goes out. Further, as an exposure time is longer, the delay is more followed. When the exposure is finished, photographed data is transmitted to the corresponding point detection section 112 (for example, a computing unit such as a personal computer). Further, in the case in which the photographed data is transmitted by using a general-purpose interface such as a USB or IP network, a transmission delay is also caused here.

Then, processing delays of the corresponding point detection section 112, the posture estimation section 113, the screen reconfiguration section 114, and the geometric correction section 111 using the transmitted photographed image are generated. Even when the corrected video is transmitted to the projector 115, in the case in which it is transmitted by using the general-purpose interface such as an HDMI (registered trademark) or a DP, the transmission delay is also caused here.

Finally, in a function (high-quality image process such as high frame rate, not illustrated) housed in the projector 115, an external input signal is accumulated in an internal frame memory once and various processes are performed. Thereafter, the video is projected and therefore the delay is also caused here.

To solve the above problem, the inertial measurement apparatus (IMU) 121 is housed in the projector 115 so as to follow a posture change due to the hand shake of the projector 115. In addition, the delay compensation circuit 122 that compensates the posture deviation due to various delays described above is housed therein. It is considered that the delay compensation circuit 122 performs correction to shift the video in the direction of eliminating the video deviation and blurring due to the hand shake.

What is described above is an outline of the present technology. The IMU 121 that is the point can instantaneously measure a posture change of the projector 115 (the response is high). However, the IMU 121 is unable to measure a shape of the projection target and a positional relationship between the projector 115 and the camera 116. The depth sensing using the camera 116 etc. is capable of measuring the shape of the projection target and the positional relationship between the projector 115 and the camera 116. However, there is not given the response such that the depth sensing is capable of following the posture change of the projector 115 due to the hand shake. To solve the above problem, by combining the depth sensing and the IMU 121, video viewing in which the video deviation and blurring due to the hand shake are corrected can be realized.

### <Advantage of Present Technology>

Next, advantages obtained by housing the IMU 121 in the projector 115 will be described.

In the present technology, by housing the IMU 121 in the projector 115, it is possible to compensate the delay caused on the side of a projector device. For example, to fulfill the housed high-quality image function, a video signal input from the outside is generally stored in a frame buffer once and the video is projected at the next vertical (V) synchronization timing. That is, various high-quality image processes are performed by the next V synchronization timing. For example, since an intermediate video is generally created from the past and present videos, the high-frame rate processing is theoretically delayed. Further, since the frame rate is doubled (60 Hz→120 Hz), a motion blur is eliminated and the video is changed into a clear and smooth video. Then, even processing of creating the intermediate video or the like is performed.

Further, among the projectors 115, some small DLP projectors have no relationship of a dot-by-dot display in a pixel shape in which a square is rotated by 45 degrees in a specification of a DMD panel. A pixel position of a video signal is deviated from the pixel position of a panel. Accordingly, the video signal needs to be interpolated so as to be correctly arranged in a pixel position of the panel once, and therefore the video signal is theoretically delayed.

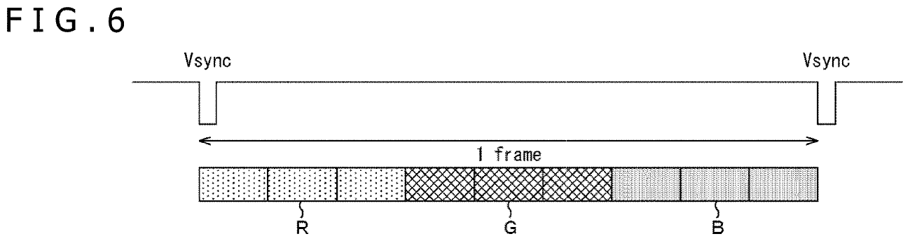

In addition, even in the case in which each color of R, G, and B is projected in a time division manner by a single-plate type panel in the color display system, the video signal is theoretically delayed. For example, in the case in which a light emitting system is adopted as illustrated in FIG. 6, the video signal is projected in the order corresponding to red (R), green (G), and blue (B) during one frame, and therefore the video signals of green and blue are delayed.

The projector 115 that houses the IMU 121 can perform delay compensation of a theoretical delay caused on the side of the projector device as described above.

<Operations of Projection imaging apparatus>

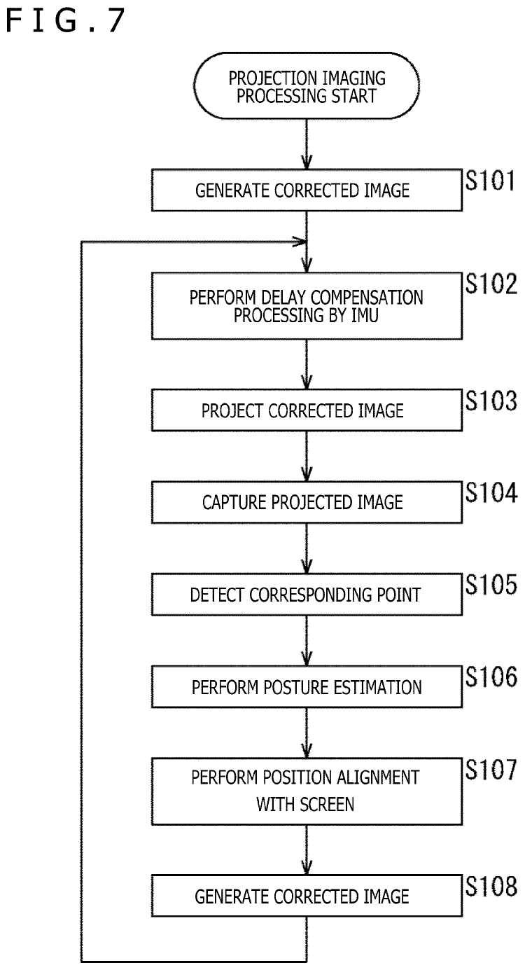

Next, projection imaging processing of the projection imaging apparatus 101 will be described with reference to a flowchart illustrated in FIG. 7.

In step S101, the geometric correction section 111 corrects an input video. The geometric correction section 111 corrects the input video by using the posture information and screen information regarding the projector in such a manner that the input video is correctly viewed, and generates a corrected image. The geometric correction section 111 outputs the generated corrected image to the projector 115.

In step S102, the delay compensation circuit 122 of the projector 115 performs delay compensation processing by the IMU 121. Specifically, a delay to be required for steps 5103 to 5108 is compensated in step S102. By using a measurement value from the IMU 121, for example, the delay compensation circuit 122 performs correction to shift the corrected image from the geometric correction section 111 in the direction of eliminating the video deviation and blurring due to the hand shake.

The geometric correction section 111 outputs the generated corrected image to the projector 115. Therefore, in step S103, the projector 115 projects the corrected image onto the screen 201.

In step S104, the camera 116 captures the projected image projected onto the screen 201 from the projector 115. Further, the camera 116 generates a captured image and supplies the captured image to the corresponding point detection section 112.

In step S105, the corresponding point detection section 112 detects a corresponding point of the input image from the captured image captured by the camera 116. The corresponding point detection section 112 supplies information regarding the detected corresponding point to the posture estimation section 113 and the screen reconfiguration section 114.

In step S106, the posture estimation section 113 performs posture estimation by using the corresponding point. The posture estimation section 113 estimates the relative posture between the projector 115 and the camera 116. Then, the posture estimation section 113 supplies the estimated posture information regarding the projector to the screen reconfiguration section 114 and the geometric correction section 111.

In step S107, the screen reconfiguration section 114 performs the position alignment with the screen. Specifically, the screen reconfiguration section 114 performs shape estimation of the screen 201 and the position alignment with the screen 201 by referring to the corresponding point and posture information regarding the projector 115 and the camera 116. Then, the screen reconfiguration section 114 supplies the results to the geometric correction section 111 as the screen information.

In step S108, the geometric correction section 111 generates the corrected image. More specifically, the geometric correction section 111 corrects the input video by using the posture information regarding the projector 115 and the camera 116 and information regarding the screen 201 in such a manner that the input video is correctly viewed, and generates the corrected image 221. Then, the geometric correction section 111 outputs the generated corrected image 221 to the projector 115. Thereafter, the process returns to step S102, and the subsequent processes are repeated. That is, in step S102, the delay compensation processing is performed by the IMU 121.

In the above, when the projector 115 houses the IMU 121, a theoretical delay caused on the side of the projector device can be compensated.

Next, an example in which an idea leads to the high-quality image using the IMU 121 will be described. The projector 115 has technology in which a signal of each sub-frame in which a light emission time of one frame is time-divided is interpolated and high-frame rated in accordance with movement of videos or technology in which a spatial resolution is increased by shifting (an optical axis of a lens is shifted in half-pixel width) a projection pixel in half-pixel width at high speed.

In the technology, it is supposed that movements of moving images or pixels of the panel are physically shifted to the lens. Further, a video signal given to each sub frame is appropriately changed to thereby realize an improvement in a visible resolution. Movements of the hand shake at each sub frame of the hand projector 115 are here caught as a minute change in movements of the video or a projection pixel position. Further, when the video signal given to each sub frame is appropriately changed, the above theoretically has a resemblance to the above-described technology and therefore leads to a visibility improvement. The IMU 121 capable of measuring fine movements due to the hand shake in each sub frame has an inherent idea of the high-quality image.

As described above, in the present technology, both the depth sensing and the IMU are combined for usage, which is difficult to realize by using either substance of the depth sensing and the IMU. The process permits videos to be projected while performing the hand shake correction by using the hand projector.

Further, by housing the IMU in the projector, even a delay caused on the side of the projector can be compensated. Further, the visibility improvement using fine movements due to the hand shake of the hand projector can also be performed. Note that, in the above descriptions, the IMU is housed in the projector and thereby the hand shake correction is performed; however, not limited to the IMU, other devices that can measure movements may be housed in the projector.

### <Personal Computer>

The series of processing described above can be performed by hardware or by software. When the series of processing is performed by software, a program included in the software is installed into a computer. Here, the computer may be a computer embedded in special hardware or may be, for example, a general personal computer which can execute various functions by installation of various programs.

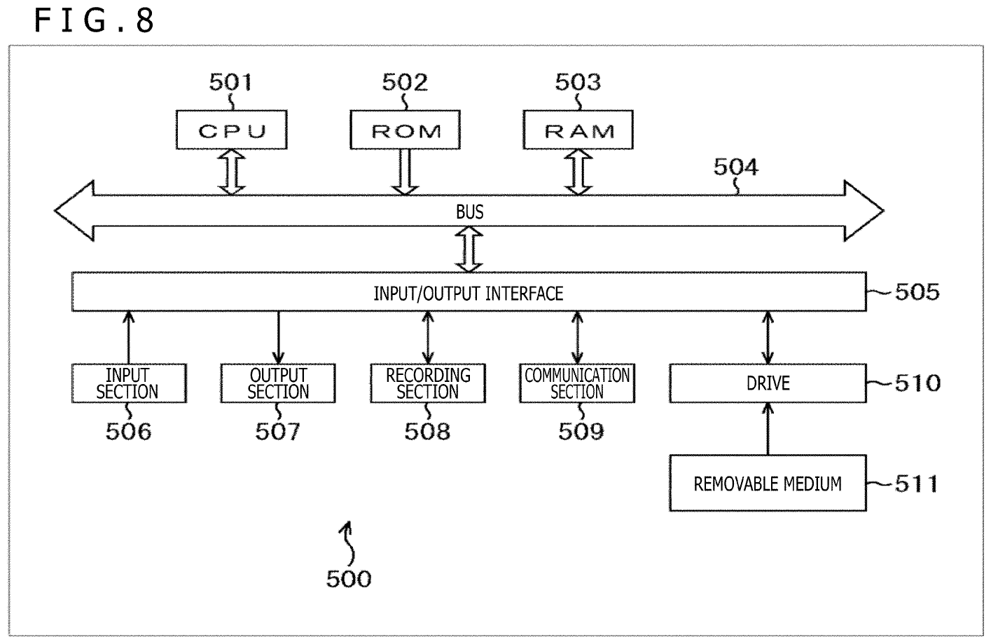

FIG. 8 is a block diagram illustrating a configuration example of hardware of a computer to perform the series of processing described above by using a program.

In a computer 500, a CPU (Central Processing Unit) 501, a ROM (Read Only Memory) 502, and a RAM (Random Access Memory) 503 are connected to each other by a bus 504.

To the bus 504, an input/output interface 505 is further connected. To the input/output interface 505, an input section 506, an output section 507, a storage section 508, a communication section 509, and a drive 510 are connected.

For example, in the case in which the computer 500 is the projection imaging apparatus 101 illustrated in FIG. 1, the input section 506 includes a keyboard, a mouse, a microphone, the camera 116 illustrated in FIG. 1, or the like. The output section 507 includes a display, a speaker, the projector 115 illustrated in FIG. 1, or the like. The storage section 508 includes a hard disk, a nonvolatile memory, or the like. The communication section 509 includes a network interface or the like. The drive 510 drives a removable medium 511 such as a magnetic disk, an optical disk, a magneto-optical disk, or a semiconductor memory.

Further, the computer 500 may configure the projector 115 itself illustrated in FIG. 1.

In the computer 500 configured as described above, the CPU 501 loads, for example, a program stored in the storage section 508 into the RAM 503 through the input/output interface 505 and the bus 504 and executes the program, whereby the series of processing described above is performed.

For example, the program executed by the computer (CPU 501) can be provided by recording the program to the removable medium 511, which functions as a package medium such as a magnetic disk (including a flexible disk), an optical disk (a CD-ROM (Compact Disc-Read Only Memory), a DVD (Digital Versatile Disc), and the like), a magneto-optical disk, or a semiconductor memory. Alternatively, the program can be provided through a wired or wireless transmission medium such as a local area network, the Internet, or a digital satellite broadcast.

In the computer 500, by mounting the removable medium 511 to the drive 510, the program can be installed into the storage section 508 through the input/output interface 505. Also, the program can be received by the communication section 509 through the wired or wireless transmission medium and can be installed into the storage section 508. In addition, the program can be previously installed into the ROM 502 or the storage section 508.

Note that the program executed by the computer may be a program in which processing is performed chronologically in an order described in this specification or may be a program in which processing is performed in parallel or at necessary timing such as when a call is performed.

Also, in this specification, a step of describing the program recorded in the recording medium includes not only the processes chronologically performed in the described order but also the processes performed in parallel or individually, which are not necessarily chronologically performed.

In addition, in this specification, the system represents the entire apparatus configured by a plurality of devices (apparatuses).

For example, the present disclosure can use the configuration of cloud computing in which a single function is shared between a plurality of apparatuses over a network and jointly executed.

Further, in the above, a constitution described as one apparatus (or one processing section) may be divided into and configured as a plurality of apparatuses (or processing sections). Conversely, constitutions described as a plurality of apparatuses (or processing sections) in the foregoing description may be collected such that they are configured as one apparatus (or one processing section). Further, a constitution other than those may naturally be added to the configuration of each apparatus (or each processing section). Further, if a constitution or operation as an entire system is substantially the same, a part of constitutions of a certain apparatus (or a certain processing section) may be included in constitutions of a different apparatus (or a different processing section). That is, the present technology is not limited to the above-described embodiments and may have various modifications within the scope without departing from the spirit of the present technology.

The preferred embodiments of the present disclosure have been described in detail above with reference to the accompanying drawings, while the present disclosure is not limited to the above examples. A person skilled in the art may find various alterations and modifications within the scope of the appended claims, and it should be understood that they will naturally come under the technical scope of the present disclosure.

Note that the present technology may have the following configurations.
(1)

A projector including:

an inertial measurement section;

a correction section configured to correct a posture deviation on the basis of a measurement value in which a geometric-corrected corrected image is measured by the inertial measurement section; and

a projection section configured to project an image in which the posture deviation is corrected by the correction section.
(2)

The projector according to the above (1), in which the correction section corrects the posture deviation due to a delay regarding any one of geometric correction, a corresponding point detection, and a posture estimation.
(3)

The projector according to the above (2), in which

in the correction section, the delay regarding any one of the geometric correction, the corresponding point detection, and the posture estimation includes a transmission delay or a processing delay.
(4)

The projector according to any one of the above (1) to (3), in which

the correction section performs correction to shift in a direction of eliminating the posture deviation.
(5)

The projector according to any one of the above (1) to (4), in which

the correction section corrects the posture deviation due to an exposure delay of an imaging section that captures a projected image projected by the projection section.
(6)

The projector according to any one of the above (1) to (5), in which

the correction section corrects the posture deviation due to a delay that is caused in the projector.
(7)

A projection method including:

correcting a posture deviation, on the basis of a measurement value in which a geometric-corrected corrected image is measured by an inertial measurement section; and

projecting an image in which the posture deviation is corrected.
(8)

An image processing system including:

an image processing apparatus including
a correction section configured to correct an input image and generate a corrected image on the basis of posture estimation information regarding a projector,
a corresponding point detection section configured to match a captured image generated by capturing a projected image that is an image in which the corrected image generated by the correction section is projected from the projector with the corrected image and detect a corresponding point, and
a posture estimation section configured to perform a posture estimation of the projector and generate the posture estimation information on the basis of the corresponding point detected by the corresponding point detection section; and

the projector including
an inertial measuring section, and
a delay compensation section configured to correct a posture deviation due to a delay regarding any one of the corresponding point detection section, the posture estimation section, and the correction section on the basis of a measurement value of the inertial measuring section.
(9)

The image processing system according to the above (8), in which

the delay regarding any one of the corresponding point detection section, the posture estimation section, and the correction section includes a transmission delay or a processing delay.
(10)

The image processing system according to the above (8) or (9), in which

the delay compensation section performs correction to shift in a direction of eliminating the posture deviation.
(11)

The image processing system according to the above (8) to (10), in which

the delay compensation section compensates an exposure delay of an imaging section that captures the projected image.
(12)

The image processing system according to any one of the above (8) to (11), in which

the delay compensation section compensates a delay that is caused in the projector.
(13)

An image processing method including:

correcting, by a correction section of an image processing apparatus, an input image and generating a corrected image on the basis of posture estimation information regarding a projector;

matching, by a corresponding point detection section of the image processing apparatus, a captured image generated by capturing a projected image that is an image in which the corrected image generated by the correction section is projected from the projector with the corrected image and detecting a corresponding point;

performing, by a posture estimation section of the image processing apparatus, a posture estimation of the projector and generating the posture estimation information on the basis of the corresponding point detected by the corresponding point detection section; and

correcting, by a delay compensation section of the projector, a posture deviation due to a delay regarding any one of the corresponding point detection section, the posture estimation section, and the correction section on the basis of a measurement value of an inertial measuring section of the projector.

### REFERENCE SIGNS LIST

101 Projection imaging apparatus, 111 Geometric correction section, 112 Corresponding point detection section, 113 Posture estimation section, 114 Screen reconfiguration section, 115 Projector, 116 Camera, 121 Inertial measurement apparatus, 122 Delay compensation circuit

1. A projector comprising:
an inertial measurement section;
a correction section configured to correct a posture deviation on a basis of a measurement value in which a geometric-corrected corrected image is measured by the inertial measurement section; and
a projection section configured to project an image in which the posture deviation is corrected by the correction section.

2. The projector according to claim 1, wherein
the correction section corrects the posture deviation due to a delay regarding any one of geometric correction, a corresponding point detection, and a posture estimation.

3. The projector according to claim 1, wherein
in the correction section, a delay regarding any one of geometric correction, a corresponding point detection, and a posture estimation includes a transmission delay or a processing delay.

4. The projector according to claim 1, wherein
the correction section performs correction to shift in a direction of eliminating the posture deviation.

5. The projector according to claim 1, wherein
the correction section corrects the posture deviation due to an exposure delay of an imaging section that captures a projected image projected by the projection section.

6. The projector according to claim 1, wherein
the correction section corrects the posture deviation due to a delay that is caused in the projector.

7. A projection method comprising:
correcting a posture deviation on a basis of a measurement value in which a geometric-corrected corrected image is measured by an inertial measurement section; and
projecting an image in which the posture deviation is corrected.

8. An image processing system comprising:
an image processing apparatus including
a correction section configured to correct an input image and generate a corrected image on a basis of posture estimation information regarding a projector, a corresponding point detection section configured to match a captured image generated by capturing a projected image that is an image in which the corrected image generated by the correction section is projected from the projector with the corrected image and detect a corresponding point, and
a posture estimation section configured to perform a posture estimation of the projector and generate the posture estimation information on a basis of the corresponding point detected by the corresponding point detection section; and
the projector including
an inertial measuring section, and
a delay compensation section configured to correct a posture deviation due to a delay regarding any one of the corresponding point detection section, the posture estimation section, and the correction section on a basis of a measurement value of the inertial measuring section.

9. The image processing system according to claim 8, wherein
the delay regarding any one of the corresponding point detection section, the posture estimation section, and the correction section includes a transmission delay or a processing delay.

10. The image processing system according to claim 8, wherein
the delay compensation section performs correction to shift in a direction of eliminating the posture deviation.

11. The image processing system according to claim 8, wherein
the delay compensation section compensates an exposure delay of an imaging section that captures the projected image.

12. The image processing system according to claim 8, wherein
the delay compensation section compensates a delay that is caused in the projector.

13. An image processing method comprising:
correcting, by a correction section of an image processing apparatus, an input image and generating a corrected image on a basis of posture estimation information regarding a projector;
matching, by a corresponding point detection section of the image processing apparatus, a captured image generated by capturing a projected image that is an image in which the corrected image generated by the correction section is projected from the projector with the corrected image and detecting a corresponding point;
performing, by a posture estimation section of the image processing apparatus, a posture estimation of the projector and generating the posture estimation information on a basis of the corresponding point detected by the corresponding point detection section; and
correcting, by a delay compensation section of the projector, a posture deviation due to a delay regarding any one of the corresponding point detection section, the posture estimation section, and the correction section on a basis of a measurement value of an inertial measuring section of the projector.
